(19) United States
(12) Patent Application Publication
(10) Pub. No.: US 2025/0018494 A1
(43) Pub. Date: Jan. 16, 2025

(54) METHOD AND APPARATUS FOR FORMING AN OVERLAY BETWEEN CUTTER POCKETS OF A POLYCRYSTALLINE DIAMOND ROCK BIT

(71) Applicant: ARC SPECIALTIES, INC., Houston, TX (US)

(72) Inventors: Daniel ALLFORD, Houston, TX (US); James WALKER, Houston, TX (US)

(21) Appl. No.: 18/350,811

(22) Filed: Jul. 12, 2023

(51) Int. Cl. B23K 10/02; E21B 10/50; E21B 10/567

(52) U.S. Cl. CPC B23K 10/02; E21B 10/50; E21B 10/567

(57) ABSTRACT

A method of forming an overlay between cutter pockets of a polycrystalline diamond rock bit includes inserting a plurality of ceramic dams respectively into the cutter pockets of the rock bit, and applying a hardfacing material using a plasma arc welding process onto a substrate of the rock bit in spaces between the ceramic dams so as to form the overlay. The ceramic dams are electrically non-conductive. Each of the ceramic dams has a cylindrical shape. The cutter pockets are drilled into the substrate of the rock bit. The ceramic dams are inserted into the respective drilled cutter pockets prior to the step of applying the hardfacing material. The ceramic dams can be removed and polycrystalline diamond bits inserted into the pockets.

### CROSS-REFERENCE TO RELATED APPLICATIONS

Not applicable.

### BACKGROUND OF THE INVENTION

### 1. Field of the Invention

The present invention relates to polycrystalline diamond rock bits. More particularly, the present invention relates to the hardfacing of surfaces onto areas between the diamond inserts of the polycrystalline rock bit. More particularly, the present invention relates to arc welding process as used for the application of applying a hardfacing material.

### 2. Description of Related Art Including Information Disclosed Under 37 CFR 1.97 and 37 CFR 1.98

Earth-boring tools are commonly used for forming (e.g., drilling and reaming) boreholes or wells in earth formations. Earth-boring tools include, for example, rotary drill bits, coring bits, eccentric bits, bicenter bits, reamers, underreamers, and mills.

Different types of earth-boring rotary drill bits are known in the art including, for example, fixed-cutter bits (which are often referred to in the art as “drag” bits), rolling-cutter bits (which are often referred to in the art as “rock” bits), superabrasive-impregnated bits, and hybrid bits (which may include, for example, both fixed-cutters and rolling cutters). The drill bit is rotated and advanced into the subterranean formation. As the drill bit rotates, the cutters or abrasive structures thereof cut, crush, shear, and/or abrade away the formation material to form the wellbore.

The drill bit is coupled, either directly or indirectly, to an end of what is referred to in the art as a “drill string,” which comprises a series of elongated tubular segments connected end-to-end that extends into the wellbore from the surface of the formation. Often, various tools and components, including the drill bit, may be coupled together at the distal end of the drill string at the bottom of the wellbore being drilled. This assembly of tools and components is referred to in the art as a “bottom-hole assembly” (BHA).

The drill bit may be rotated within the wellbore by rotating the drill string from the surface of the formation, or the drill bit may be rotated by coupling the drill bit to a downhole motor, which is also coupled to the drill string and disposed proximate the bottom of the wellbore. The downhole motor may comprise, for example, a hydraulic Moineau-type motor having a shaft, to which the drill bit is attached, that may be caused to rotate by pumping fluid (e.g., drilling mud or fluid) from the surface of the formation down through the center of the drill string, through the hydraulic motor, out from nozzles in the drill bit, and back up to the surface of the formation through the annular space between the outer surface of the drill string and the exposed surface of the formation within the wellbore.

The materials of earth-boring tools need to be relatively hard and wear-resistant to avoid excessive wear during use of the tools. In an effort to increase wear-resistance of earth-boring tools, composite materials have been applied to the surfaces of drill bits that are subjected to abrasion, erosion, or to both abrasion and erosion. These composite materials are often referred to as “hardfacing” materials. Hardfacing materials typically include grains of hard material embedded within a continuous matrix phase. The continuous matrix phase generally comprises a metal alloy, and is often referred to in the art as a metal “binder,” as it binds the grains of hard material together.

For example, hardfacing materials often include tungsten carbide particles dispersed throughout an iron-based, nickel-based, or cobalt-based metal alloy matrix. The tungsten carbide particles are relatively hard compared to the matrix material, and the matrix material is relatively tough compared to the tungsten carbide particles.

Tungsten carbide particles used in hardfacing materials may comprise one or more of cast tungsten carbide particles, sintered tungsten carbide particles, and macrocrystalline tungsten carbide particles. The tungsten carbide system includes two stoichiometric compounds, WC and W2C. Cast tungsten carbide generally includes a eutectic mixture of the WC and W2C compounds. Sintered tungsten carbide particles include relatively smaller particles of WC bonded together by a matrix material. Cobalt and cobalt alloys are often used as matrix materials in sintered tungsten carbide particles. Finally, macrocrystalline tungsten carbide particles generally consist of single crystals of WC.

Various techniques known in the art may be used to apply hardfacing to a surface of an earth-boring tool. For example, automated and manual welding processes may be used to apply hardfacing to an earth-boring tool. In some manual processes, a welding rod that comprises the hardfacing is provided, and a torch (e.g., an oxyacetylene torch or an arc-welding torch) is used to heat an end of the rod and, optionally, the surface of the tool to which the hardfacing is to be applied. The end of the rod is heated until at least the matrix material begins to melt. As the matrix material at the end of the rod begins to melt, the melting hardfacing is applied to the surface of the tool. The hard particles dispersed within the matrix material are also applied to the surface with the molten matrix material. After application, the molten matrix material is allowed to cool and solidify.

Such welding rods may comprise a substantially solid, cast rod of the hardfacing, or the may comprise a hollow, cylindrical tube formed from the matrix material of the hardfacing and filled with hard particles (e.g., tungsten carbide particles). In welding rods of the tubular configuration, at least one end of the hollow, cylindrical tube may be sealed. The sealed end of the tube then may be melted or welded onto the desired surface on the earth-boring tool. As the tube melts, the tungsten carbide particles within the hollow, cylindrical tube mix with the molten matrix material as it is deposited onto the surface of the tool. An alternative technique involves forming a cast rod of the hardfacing.

Flame spray processes are also used to apply hardfacings to earth-boring tools. In a flame spray process, a powder comprising the hard particles and particles of the matrix material is carried by a pressurized fluid (e.g., a pressurized gas) to a nozzle. The powder mixture is sprayed out from the nozzle and through a flame toward the surface of the tool to which the hardfacing is to be applied. The flame causes the particles of matrix material to at least partially melt. As the material is sprayed onto the tool, the molten matrix material cools and solidifies, and the hard particles become embedded in the matrix material to form the hardfacing on the surface of the tool.

Various types of arc welding processes are known in the art and may be used to apply hardfacing to a surface of an earth-boring tool. For example, metal-inert gas (MIG) welding processes, tungsten-inert gas (TIG) welding processes, and plasma-transferred arc (PTA) welding processes may be used to apply hardfacing to a surface of an earth-boring tool.

When the rotary drill bit is a polycrystalline diamond rock bit, it is important to realize that the diamond inserts of such a rock bit are extremely expensive. As such, it is important to be able to preserve the integrity of the rock bits for as long as possible. Once the substrate material of the rock bit has been sufficiently damaged or worn, the diamond inserts can be removed and then re-utilized in a subsequent new rock bit. Typically, the application of hardfacing material has been carried out using a thermal spray or oxy-fuel process. Typically, in order to prevent this coating from getting into the diamond insert-receiving pocket, a graphite dam is inserted into the pocket. As such, the wear-resistant overlay will be applied by the thermal spray or oxy-fuel process between the inserted graphite dams.

Better coatings can be applied using a plasma-transferred arc or other arc welding processes. Unfortunately, the welding are tends to be conducted through the graphite dam rather than impinging on the steel. The use of the graphite dams has forced the overlay to be performed by processes other than by arc welding. These thermal spray or oxy-fuel processes are not very well adapted to robotic manipulation. The modern robots cannot accommodate the use of a welding torch. On the other hand, robots can be uniquely adapted to arc welding processes. Unfortunately, in the prior art, the arc welding process cannot be used because of the graphite dams. In other words, the electrical flow will be toward the graphite dam (along the path of least resistance), rather than toward the steel substrate of the rock bit.

Referring to FIG. 1, there is shown an example of a polycrystalline diamond rock bit of the prior art. FIG. 1 is a side elevational view of the polycrystalline diamond rock bit 10 to which the present invention is applied. The polycrystalline rock bit 10 includes a bit body 12 and a plurality of rotatable cutter assemblies 14. The bit body 12 may include a plurality of integrally formed bit legs 16 having plugs 40. Threads 18 are formed on the upper end of the bit body 12 for connection to a drill string (not shown). The bit body 12 may have nozzles for discharging drilling fluid into a borehole, which may be returned along with cuttings up to the surface during the drilling operation. Each of the rotatable cutter assemblies 14 includes a cone 22 having a particle-matrix composite material (e.g., cobalt cemented tungsten carbide). The diamond cutters 24 are inserted into recesses or pockets formed in the surface of the cones 22. Each cone 22 includes a conical gage surface 26. Each cone 22 has a unique configuration of diamond insert cutters 24 or cutting elements such that the cones 22 may rotate in close proximity to one another without mechanical interference.

FIG. 2 is a cross-section of a pocket 30 of a bit being repaired or rebuilt using conventional techniques. In this stage of the rebuilding or construction process, the pocket 30 supports the dam 32 which has been tapped into the pocket 30 to create a temporary press or interference-tight fit. With the dam 32 positioned, hardfacing material 34 is applied to the substrate 36.

The hardfacing material 34 is applied to the outer surface of the substrate 36 of the bit. The hardfacing material 34 is customarily applied by heating a hardfacing powder or other material in a solid-state to a molten state and applying it to the substrate 36 of the bit. In the molten state, the hardfacing material 34 bonds with the steel of the substrate 36 securing the hardfacing coating in place. This is done carrying out flame spraying or gas torches.

The hardfacing material 34 typically does not flow over or weld with or adhere to the material of the dam 32. An oxide layer on the surface of the dam 32 inhibits the flow of the hardfacing material 34 being applied with the torch. The oxide causes the molten hardfacing material to bead or ball up on the dam 32. In the prior art, the dam 32 is a graphite plug that fits within the pocket 16 until the hardfacing operation is complete. This works effectively with such flame spraying or gas torches. However, when used with arc welding, the graphite dam 32 will attract the electrical charge and inhibit the ability of the arc welding to form the hardfacing 34.

FIG. 3 illustrates that the hardfacing material 34 has been applied and cured. The dam 32 is removed. A cutter 38 is inserted into the pocket 30. The cutter 38 is secured within the pocket 30 by the application of a brazing material (not illustrated) or by other conventional techniques. A brazing material can then be used so as to secure the diamond bit into the pocket 30. This brazing material effectively fixes the diamond insert within the pocket 30.

In the past, various patents have issued with respect to the hardfacing of polycrystalline diamond rock bits. For example, U.S. Pat. No. 6,772,849, issued on Aug. 10, 2004 to Oldham et al., teaches a protective overlay coating for polycrystalline diamond drill bits. This coating increases the durability of a drill bit having a drill body with at least one blade disposed thereon. There is at least one cutter pocket disposed on the blade. At least one cutter is disposed in the cutter pocket. The method includes brazing the cutter to the cutter pocket so that a braze material is disposed between the cutter pocket and the cutter. This creates an exposed surface. A portion of the exposed surface is overlaid with a hardfacing material. The hardfacing material includes a binder having a melting point selected to avoid damaging the cutter.

U.S. Pat. No. 7,703,555, issued on Apr. 27, 2010 to J. L. Overstreet, shows an abrasive wear-resistant material including a matrix and sintered and cast tungsten carbide granules. A device for use in drilling subterranean formations includes a first structure secured to a second structure with a bonding material. An abrasive wear-resistant material covers the bonding material. The first structure includes a drill bit body. The second structure includes a cutting element. A method for applying the abrasive wear-resistant material to the drill bit includes providing the bit, mixing sintered and cast tungsten carbide granules in a matrix material to provide a pre-application material, heating the pre-application material to melt the matrix material, applying the pre-application material to the bit, and solidifying the material.

U.S. Pat. No. 8,322,466, issued on Dec. 4, 2012 to J. S. Bird, describes a hardfacing for protecting surfaces of drill bits. The hardfacing includes tungsten carbide particles or pellets formed with an optimum weight percentage of binding material and dispersed within and bonded to a matrix deposit.

U.S. Pat. No. 8,471,182, issued on Jun. 25, 2013 to Stauffer et al., describes a system and method for automatic or robotic application of hardfacing to the surface of a steel-toothed cutter of an earth-boring rock bit. The system incorporates a grounded adapter plate mounted to a robotic arm for grasping and manipulating a rock bit cutter, particularly a hybrid rock bit cutter, beneath an electrical or photonic energy welding source, such as a plasma arc welding torch manipulated by a positioner. In this configuration, the torch is positioned substantially vertically and oscillated along a horizontal axis as the cutter is manipulated along a target path for the distribution of hardfacing.

U.S. Pat. No. 8,969,754, issued on Mar. 3, 2015 to Luce et al., teaches a method for automated application of hardfacing material to drill bits. This method comprises providing a vertically-oriented plasma transfer arc torch secured to a positioner having controllable movement in a substantially vertical plane. A rolling cutter is secured to a chuck mounted on an articulated arm of a robot. A surface of a tooth of the rolling cutter is positioned in a substantially perpendicular relationship beneath the torch. The torch is oscillated along a substantially horizontal axis. The rolling cutter is moved with the oscillating arm of the robot in a plane beneath the oscillating torch. A hardfacing material is deposited on the tooth of the rolling cutter.

U.S. Pat. No. 9,289,864, issued on Mar. 22, 2016 to Johnson et al., provides a method for forming pockets of a drill bit and includes inserting a displacement plug in a cutter pocket defined by a substrate of a drill bit. A hardfacing material is applied to the substrate. The heat from the plasma arc welding torch reduces an oxide layer on the outer surface of the displacement plug. The molten hardfacing material flows over the displacement plug and wets against the displacement plug. The displacement plug is then removed to reveal a final cutter pocket configured to receive a cutter. The cutter is secured in the cutter pocket by brazing.

U.S. Pat. No. 9,359,827, issued on Jun. 7, 2016 to J. W. Eason, discloses a hardfacing composition including grains of hard material embedded within a cobalt-based metal alloy and includes ruthenium. The hardfacing composition is applied to earth-boring tools. The hardfacing is applied to the earth-boring tool by embedding grains of hard material in a molten cobalt-based metal alloy on a surface of the earth-boring tool and then cooling and solidifying the molten cobalt-based metal alloy.

U.S. Pat. No. 9,731,384, issued on Aug. 15, 2017 to Chen et al., provides a method for depositing a braze material adjacent a first body and a second body. This method includes heating the braze material and forming a transient liquid phase. The transient liquid phase is transformed to a solid phase and forms a bond between the first body and the second body. The braze material includes copper, silver, zinc, magnesium and at least one material selected from among nickel, tin, cobalt, iron, phosphorus, indium, lead, antimony, cadmium and bismuth.

U.S. Patent Application Publication No. 2006/0254830, published on Nov. 16, 2006 to R. P. Radtke, describes a cutting element and method for forming a cutting element. The cutting element includes a substrate, a diamond layer, a metal interlayer between the substrate and the diamond layer, and a braze joint securing the diamond layer to the substrate.

International Publication No. WO 2008/112262, published on Sep. 18, 2008 to Duggan, provides a method for forming pockets for receiving drill bit cutting elements. This method includes machining at least one recess to define at least one surface of a cutting element pocket using a cutter oriented at an angle to a longitudinal axis of the cutting element pocket. A bit body is formed and at least one cutting element is formed using a rotating cutter oriented in an angle relative to a longitudinal axis of the cutting element pocket. The bit body has a first surface having a lateral side wall of a cutting element pocket, a second surface defining an end wall of the cutting element pocket, and another surface located between the first and second surfaces that extends into the body to enable a cutting element to abut against an area of the lateral side wall and end wall of the pocket.

It is an object of the present invention to provide an apparatus and method that avoids conducting the arc of the arc welder through the insert.

It is another object of the present invention to provide a method and apparatus for forming an overlay which provides improved wear resistance.

It is another object of the present invention to provide a method for forming an overlay which is more adaptable to automated machinery and robots.

It is another object of the present invention to provide a method for forming an overlay which allows a wear-resistant coating to be deposited into an optimal shape.

It is another object of the present invention to provide a method for forming an overlay that effectively protects the steel substrate of the polycrystalline diamond rock bit.

It is a further object the present invention to provide a method for forming an overlay that avoids any exposed steel on the rock bit.

It is a further object of the present invention provide a method for forming an overlay that avoids the use of graphite plugs in the pockets of the drill bit.

It is still another object of the present invention to provide a method for forming an overlay which extends the life of the drill bit and allows the diamond inserts to be reused.

These and other objects and advantages of the present invention will become apparent from a reading of the attached specification and appended claims.

### BRIEF SUMMARY OF THE INVENTION

The present invention is a method for forming an overlay between cutter pockets of a polycrystalline diamond rock bit. The method includes the steps of: (1) inserting a plurality of ceramic dams respectively into the cutter pockets of the polycrystalline diamond rock bit; and (2) applying a hardfacing material using a plasma arc welding process onto a substrate of the polycrystalline diamond rock bit in spaces between the plurality of ceramic dams so as to form the overlay. The ceramic dams are electrically non-conductive. In the preferred embodiment of the present invention, each of the plurality of ceramic dams has a cylindrical shape. The substrate will be a steel body. The hardfacing material is, in the preferred embodiment, a tungsten carbide material. In particular, this tungsten carbide material is bonded within a chrome-nickel-silicon-boron matrix.

The cutter pockets are drilled into the steel body of the polycrystalline diamond rock bit. The plurality of ceramic dams slide into the respective drilled cutter pockets prior to the step of applying the hardfacing material. The ceramic dams are removed from the cutter pockets after the step of applying the hardfacing material. The polycrystalline diamond bits are respectively inserted into the ceramic dam-removed pockets. Ultimately, the installed polycrystalline diamond bits are brazed to the rock bit. The step of applying the hardfacing material can, in an embodiment of the present invention, be robot-controlled.

The present invention is also an article for use in forming a hardfacing onto a body of a polycrystalline diamond rock bit. The insert comprises a ceramic body having an outer diameter adapted to fit into a diamond bit-receiving pocket of the body of the polycrystalline diamond rock bit. The ceramic body is electrically non-conductive. The ceramic body has a cylindrical shape. The ceramic body will have a length greater than a depth of the diamond bit-receiving pocket.

The present invention is also a method of forming a polycrystalline diamond rock bit. This method includes the steps of: (1) forming a steel body having an outer surface; (2) drilling a plurality of holes to a desired depth into the outer surface of the steel body; (3) inserting ceramic dams respectively into the drilled plurality of holes; (4) applying a hardfacing material using a plasma arc welding process onto the outer surface of the steel body in spaces between the plurality of ceramic dams; (5) removing the plurality of ceramic dams from the plurality of holes subsequent to the step of applying the hardfacing material; and (6) inserting diamond inserts into the ceramic dam-removed plurality of holes.

In this method of the present invention, the plurality of ceramic dams have a length greater than a depth of the plurality of drilled holes. In the preferred embodiment the present invention, the hardfacing material is tungsten carbide in a chrome-nickel-silicon-boron matrix. The step of applying the hardfacing material can be robot-controlled. The inserted diamond inserts are brazed onto the steel body so as to fix the inserted diamond inserts respectively in the plurality of holes.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of a prior art polycrystalline diamond rock bit as used for oil and gas well drilling.

FIG. 2 is a cross-sectional view showing a prior art step for forming a hardfacing on a substrate of the drill bit.

FIG. 3 is a cross-sectional view showing a further step in the forming of a hardfacing on the substrate of a drill bit.

FIG. 4 is a cross-sectional view showing an initial step in the formation of the polycrystalline diamond rock bit of the present invention.

FIG. 5 is a magnified cross-sectional view showing the installation of the ceramic dams into the pockets of the polycrystalline diamond rock bit.

FIG. 6 is a cross-sectional view showing the installation of the diamond inserts into the pockets of the polycrystalline diamond rock bit as hardfaced with the process of the present invention.

FIG. 7 is a schematic illustration of the use of a robot for the formation of the hardfacing between the cutter pockets of the polycrystalline rock bit of the present invention.

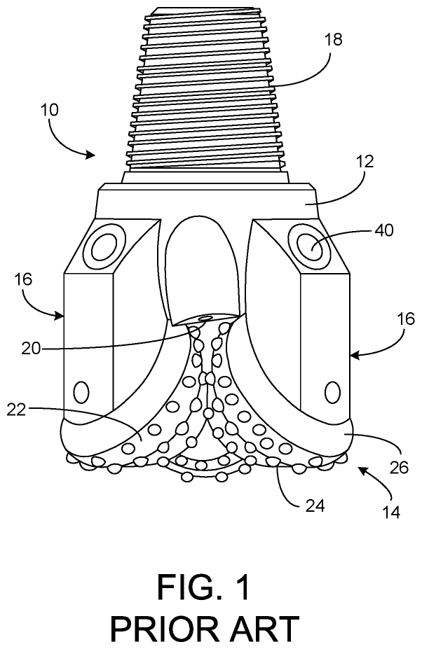

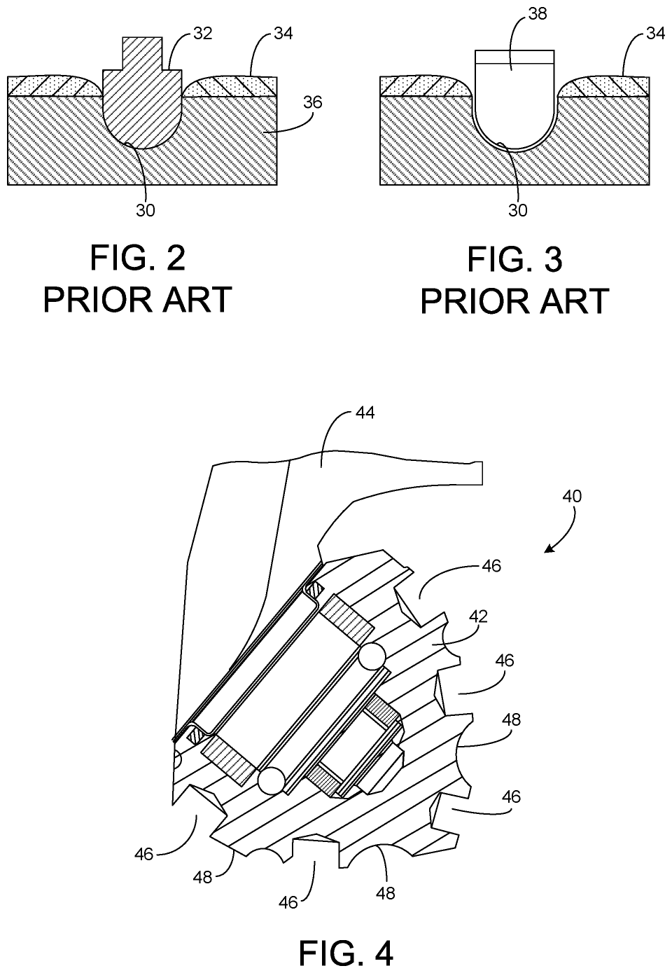

### DETAILED DESCRIPTION OF THE INVENTION

FIG. 4 illustrates an early step in the formation of the overlay of the polycrystalline diamond rock bit 40 of the present invention. Initially, it can be seen that the polycrystalline diamond rock bit 40 has a body 42 formed of a steel material. This body can be secured to a support 44 and adapted for positioning for the purposes of applying the overlay.

In FIG. 4 there are a plurality of pockets 46 that are formed into the steel body 42. Pockets 46 can be drilled into the steel material of the body 42 for a desired depth. As a result, there will be spaces 48 between the respective pockets 46. The hardfacing material will be applied on to these spaces 48 spaces or surfaces 48 between the respective pockets 46.

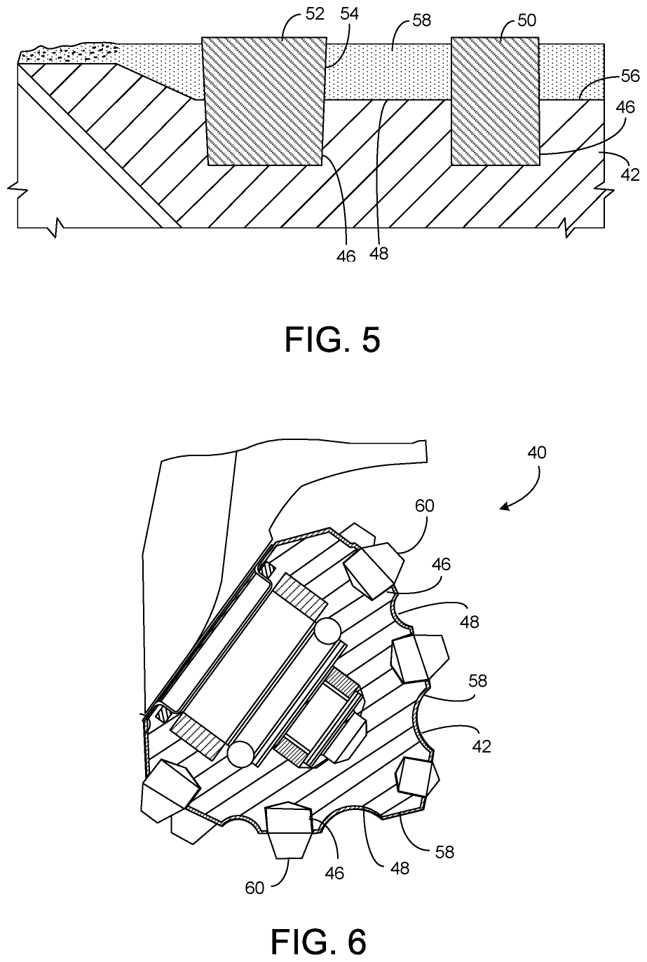

FIG. 5 shows a further step in the process of the present invention. FIG. 5 is a close-up view showing the steel substrate of the body 42 as having pockets 46 drilled thereinto. In FIG. 5, it can be seen that there is a first ceramic dam 50 positioned in one of the pockets 46 and a second ceramic dam 52 positioned in the other pocket 46. Each of the inserts 50 and 52 is formed of a ceramic material. Each of the ceramic dams 50 and 52 will be formed of a non-conductive ceramic material. It can be seen that the ceramic dams 50 and 52 each have a length dimension that is greater than the depth of the pocket 46. As such, a portion 54 of the ceramic dams 50 and 52 will extend outwardly of the outer surface 56 of the body 42.

A hardfacing material 58 is then applied over the outer surface 56. This hardfacing material 58 is applied using a plasma arc welding process. This hardfacing material 58 will be located in the spaces 48 between the adjacent pockets 46. The hardfacing material, in the preferred embodiment of the present invention, is tungsten carbide and, in particular, tungsten carbide in a chrome-nickel-silicon-boron matrix.

Since the ceramic dams 50 and 52 are non-conductive, the hardfacing material 58 can be applied onto the outer surface 56 in an arc-welding process. The non-conductive ceramic dams 50 and 52 will not electrically attract the arc from the arc welding. As such, the hardfacing 58 can be applied in an even and efficient manner.

Ultimately, after the hardfacing 58 has been formed, each of the ceramic dams 50 and 52 can be removed by pulling the ceramic dams 50 and 52 from the respective pockets 46. The removal of the ceramic dams 50 and 52 will leave suitable spaces or pockets for the receipt of the polycrystalline diamond inserts therein.

FIG. 6 shows in particular, the insertion of the polycrystalline diamond inserts 60 within the respective pockets 46. Each of the polycrystalline diamond inserts 60 has a portion extending outwardly of the outer surface of the steel body 42 of the rock bit 40. Each of the polycrystalline diamond inserts can be affixed within these pockets 46 by brazing in accordance with the known art. It can be seen that the hardfacing material 58 extends in those spaces 48 between the respective pockets 46.

The polycrystalline diamond inserts are brazed in the pockets drilled into the steel body of the rock bit. In between these pockets, the exposed steel body can wear due to the abrasion caused by the rock chips during drilling. Traditionally, these exposed steel areas are protected by applying a wear-resistant coating. To prevent this coating from getting into the pocket, a graphite dam is inserted into the pocket in the prior art. These coatings are generally applied using a thermal spray or oxy-fuel process.

Better coatings can be applied using a plasma-transferred arc or other arc welding processes. However, the welding arc tends to be conducted through the graphite dam rather than impinging on the steel. In the present invention, the graphite dams are replaced with non-conductive ceramic dam. As such, the present invention allows for the use of an arc welding overlay technique to provide improved wear resistance and also to simplify the automation of the wear-resistant coating process. The ceramic dam forms the wear-resistant coating deposit into the optimal shape to protect the steel substrate between the polycrystalline diamond inserts.

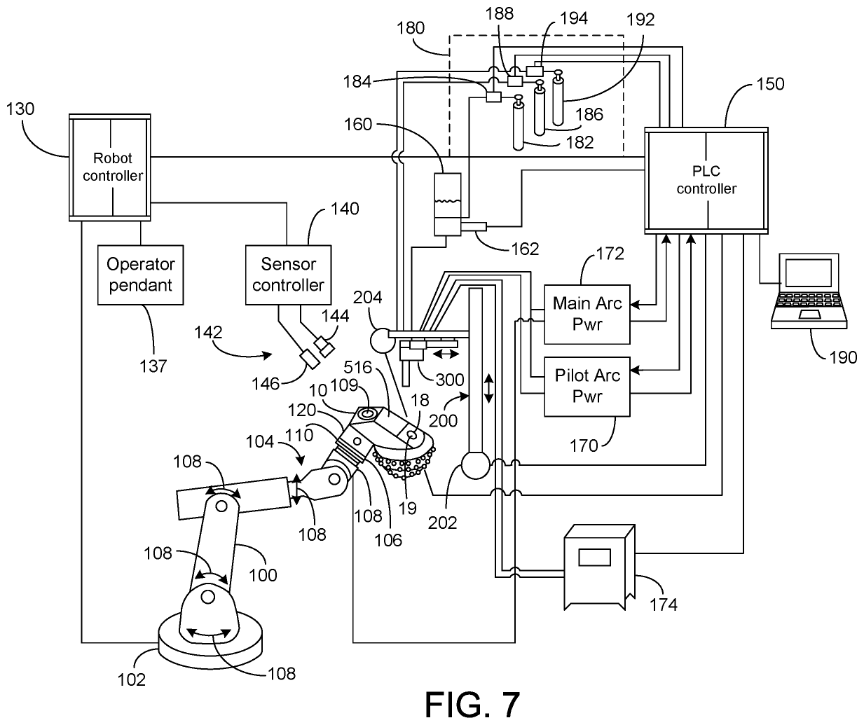

Importantly, in the present invention, the arc welding process can be carried out by using at least one robot in association with the rock bit. The robot (or robots) can be utilized so as to drill the holes into the steel body and also to apply the hardfacing into those spaces between the pockets that are drilled into the steel body. FIG. 7 shows an example of an embodiment of which the arc welding process is utilized for these operations. In FIG. 7, it can be seen that there is an industrial robot 100 having a stationary base 102 and an articulated arm 104. Articulated arm 104 has a distal end 106. Robot 100 has a plurality of axes of rotation 108 about which controllable movement permits wide-range positioning of the distal end 106 relative to base 102. Robot 100 has six or more independently controllable axes of movement between base 102 and the distal end 106 of arm 104. FIG. 7 shows a drill bit 109 attached to the articulated arm 104.

An adapter 110 is attached to the distal end 106 of the robot 100. Adapter 110 has a ground connector 112 for attachment to an electrical ground cable (not shown). A chuck 120 is attached to adapter 110. Chuck 120 securely grips the drill bit 109. A heat sink, or thermal barrier may be provided between the adapter and the drill bit 109 to prevent heat from causing premature failure of the rotating axis at distal end 106 of articulated arm 104. The thermal barrier is an insulating spacer (not shown) located between the drill bit 109 and the distal end 106 of robot 100.

A robot controller 130 is electrically connected to robot 100 for programmed manipulation of robot 100, including movement of articulated arm 104. An operator pendant 137 can be provided as electrically connected to robot controller 130 for convenient operator interface with robot 100. A sensor controller 140 is electrically connected to robot controller 130. Sensor controller 140 can also be connected at electrically to a programmable logic controller 150. A plurality of sensors 142 are electrically connected to sensor controller 140. Sensors 142 can include a camera 144 and/or a contact probe 146. Alternatively, sensors 142 can include suitable laser proximity sensors 148. Sensors 140 to provide interactive information to robot controller 130, such as the distance between the arc welder 300 and the drill bit 109. A programmable logic controller 150 is electrically connected to robot controller 130. Programmable logic controller 150 provides instructions to auxiliary controllable devices that operate in coordinated and programmed sequence with robot 100.

A powder dosage system 160 may be provided for dispensing powder when the plasma transferred arc welding process is used to weld the hardfacing to the drill bit 109. A driver 162 is electrically connected to the programmable logic controller 150 for dispensing the powder at a predetermined, desired rate. A pilot arc power source 170 and a main arc power source 172 are electrically connected to the programmable logic controller 150. A cooling unit 174 is electrically connected to the programmable logic controller 150. A data-recording device 190 may also be electrically connected to the programmable logic controller 150.

A gas-dispensing system 180 is provided. A transport gas source 182 supplies transport gas through a flow controller 184 to carry or transport welding powder for the plasma arc welding system. Flow controller 184 is electrically connected to the programmable logic controller 150 so as to control the operation of flow controller 184 and the flow and flow rate of the transport gas. A plasma gas source 186 supplies gas for plasma formation to a flow controller 188. Flow controller 188 is electrically connected to the programmable logic controller. This controls the operation of flow controller 188 and the flow and flow rate of the plasma gas. Similarly, a shielding gas source 192 supplies shielding gas to a flow controller 194 for any welding process requiring a shielding gas. Flow controller 194 is electrically connected to the programmable logic controller 150 which controls the operation of flow controller 194 and the flow and flow rate of the shielding gas.

The arc welder 300 is, preferably, a plasma transferred arc welding torch. A welding powder can be supplied to the arc welder 300 and plasma, transport and shielding gases may be supplied to the arc welder 300 as necessary or desirable from their respective supplies and controllers in the gas-dispensing system 180. The arc welder 300 is secured to a position on positioning table 200 which grips and manipulates the welder 300. The welder 300 may be capable of programmable positioning in three-dimensional space. The positioner 200 can include a vertical drive 202 and a horizontal drive 204. Drives 202 and 204 may be tooth belts, ballscrews, a toothed rack, pneumatic, or other means. In particular, in the preferred embodiment of the present invention, the arc welder 300 can be controlled by an independent industrial robot such as robot 100 separate from robot 100. The arm of the robot can be utilized so as to properly position the arc welder, as needed.

The foregoing disclosure and description of the invention is illustrative and explanatory thereof. Various changes in the details of the illustrated construction or in the steps of the described method can be made within the scope of the appended claims without departing from the true spirit of the invention. The present invention should only be limited by the following claims and their legal equivalents.

We claim:

1. A method of forming an overlay between cutter pockets of a polycrystalline diamond rock bit, the method comprising:
inserting a plurality of ceramic dams respectively into the cutter pockets of the polycrystalline diamond rock bit; and
applying a hardfacing material using a plasma arc welding process onto a substrate of the polycrystalline diamond rock bit in spaces between the plurality of ceramic dams so as to form the overlay.

2. The method of claim 1, wherein the plurality of ceramic dams are electrically non-conductive.

3. The method of claim 1, wherein each of the plurality of ceramic dams has a cylindrical shape.

4. The method of claim 1, wherein the substrate is a steel body.

5. The method of claim 1, wherein the hardfacing material is tungsten carbide.

6. The method of claim 1, wherein the hardfacing material is tungsten carbide in a chrome-nickel-silicon-boron matrix.

7. The method of claim 1, further comprising:
drilling the cutter pockets into the substrate of the polycrystalline diamond rock bit.

8. The method of claim 7, the step of inserting comprising:
sliding the plurality of ceramic dams into the respective drilled cutter pockets prior to the step of applying the hardfacing material.

9. The method of claim 1, further comprising:
removing the plurality of ceramic dams from the cutter pockets after the step of applying the hardfacing material;
inserting the polycrystalline diamond bits respectively into the ceramic dam-receiving pocket; and
brazing the installed polycrystalline diamond bits to the polycrystalline diamond rock bit.

10. The method of claim 1, wherein the step of applying the hardfacing material is robot-controlled.

11. An article for use in forming a hardfacing onto a body of a polycrystalline rock bit, the article comprising:
a ceramic body having an outer diameter adapted to fit into a diamond bit-receiving pocket of the body of the polycrystalline diamond rock bit.

12. The article of claim 11, wherein the ceramic body is electrically non-conductive.

13. The article of claim 12, wherein the ceramic body has a cylindrical shape.

14. The article of claim 13, wherein the ceramic body has a length greater than a depth of the diamond bit-receiving pocket.

15. A method of forming a polycrystalline diamond rock bit, the method comprising:
forming a steel body having an outer surface;
drilling a plurality of holes to a desired depth into the outer surface of the steel body;
inserting a plurality of ceramic dams respectively into the drilled plurality of holes;
applying a hardfacing material using a plasma arc welding process onto the outer surface of the steel body in spaces between the plurality of ceramic dams;
removing the plurality of ceramic dams from the plurality of holes subsequent to the step of applying the hardfacing material; and
inserting diamond inserts into the ceramic dam-removed plurality of holes.

16. The method of claim 15, wherein the plurality of ceramic each have a length greater than a depth of the plurality of drilled holes.

17. The method of claim 15, wherein the hardfacing material is tungsten carbide in a chrome-nickel-silicon-boron matrix.

18. The method of claim 15, wherein the step of applying the hardfacing material is robot-controlled.

19. The method of claim 15, wherein each of the plurality of ceramic dams is cylindrical and is non-conductive.

20. The method of claim 15, further comprising:
brazing the inserted diamond inserts onto the steel body so as to fix the inserted diamond inserts respectively in the plurality of holes.
